(19) United States
(12) Patent Application Publication
(10) Pub. No.: US 2026/0340731 A1
(43) Pub. Date: Oct. 29, 2026

(54) QUALIFIED ASSET-COLLATERALIZED ASSET-BACKED SECURITY WITH SHARED UPSIDE PARTICIPATION AND CREDIT RATING INTEGRATION

(71) Applicant: Wave Digital Assets Holdings LLC, Los Angeles, CA (US)

(72) Inventors: Laslo Borsai, Santa Monica, CA (US); Laslo Borsai, Los Angeles, CA (US); Nicole Trudeau, Seattle, WA (US)

(21) Appl. No.: 19/655,970

(22) Filed: Apr. 23, 2026

Related U.S. Application Data
(60) Provisional application No. 63/793,745, filed on Apr. 24, 2025.
(60) Provisional application No. 63/890,502, filed on Sep. 30, 2025.

(51) Int. Cl. G06Q 40/06

(52) U.S. Cl. CPC G06Q 40/063

(57) ABSTRACT

A commodity-collateralized asset-backed security framework in which a nationally recognized statistical rating organization assigns a formal credit rating to fixed-income notes issued by a State Conduit Issuer and secured by Qualifying Asset collateral, including Bitcoin or precious metals, held through a bankruptcy-remote trust structure with perfected first-priority security interests, automated intraday collateral monitoring, mandatory liquidation triggers, and a make-whole redemption feature, wherein an indenture-embedded contractual participation right entitles noteholders to a defined percentage of any appreciation in the market price of the Qualifying Asset above an initial reference price, payable at redemption or maturity in cash or in kind, floored at zero so that noteholders bear no downside exposure, with additional participation allocated to the State Conduit Issuer and residual upside retained by the Originator/Sponsor.

### CROSS REFERENCE TO RELATED APPLICATIONS

This application claims priority to U.S. provisional patent applications 63/793,745, filed on Apr. 24, 2025, and U.S. provisional patent application 63/890,502, filed on Sep. 30, 2025, and U.S. provisional patent 64/021,645, filed on Mar. 30, 2026, each incorporated herein by reference.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The present invention relates to structured finance instruments and, more particularly, to a novel method and system for securitizing a Qualifying Asset (as defined herein) as collateral for the issuance of rated, fixed-income debt securities that incorporate a contractual mechanism for sharing Bitcoin price appreciation between the collateral sponsor and bond investors—herein referred to as a Shared Upside Model or Participation Certificate, each as defined herein below. The invention further relates to the specific documentary, legal, and operational sequencing required to achieve a formal credit rating from a nationally recognized statistical rating organization (NRSRO) for such a Qualifying Asset-collateralized instrument.

Cryptocurrency is a type of digital or virtual currency that uses cryptography for security and operates on decentralized networks based on blockchain technology. Unlike traditional currencies issued by governments and central banks, cryptocurrencies are typically maintained by a distributed ledger system, where all transactions are recorded across a network of computers. This decentralized nature helps ensure transparency, reduces the risk of fraud, and eliminates the need for intermediaries like banks. Bitcoin, launched in 2009, was the first and remains the most well-known cryptocurrency, but many others have emerged since, including Ethereum and Ripple, among others, each with unique features and use cases. Cryptocurrencies can be used for a variety of purposes, such as peer-to-peer transactions and smart contracts, among other possibilities.

Cryptocurrency transactions are transacted on a blockchain, which is a decentralized, distributed ledger. Blockchain transactions are digital transactions that are recorded on the decentralized, distributed ledger. Each transaction is verified by a network of computers, or nodes, through a consensus mechanism—such as proof of work or proof of stake—before being added to a block. Once a block is filled with verified transactions, it is cryptographically linked to the previous block, forming a chronological chain that is resistant to tampering and fraud. This process provides transparency, traceability, and security, as every participant in the network of computers has access to a copy of the blockchain and can verify the history of transactions.

A crypto wallet is a digital tool that allows users to store, manage, and interact with cryptocurrencies. It contains private and public keys, which are used for sending and receiving digital assets on blockchain networks. The private key is kept secret and acts as a digital signature, authorizing transactions, while the public key is used to generate wallet addresses that others can use to send digital assets. Crypto wallets come in various forms, including software wallets (desktop, mobile, or web-based) and hardware wallets (physical devices that store keys offline for enhanced security). Some wallets are custodial, meaning a third party manages the private keys on behalf of the user. In contrast, non-custodial wallets give users full control over their keys and assets.

The global fixed-income market exceeds $140 trillion in outstanding debt. Institutional investors—including insurance companies, pension funds, endowments, and bank proprietary desks—require rated, fixed-income instruments for regulatory and portfolio compliance reasons. Bitcoin, the world's largest digital commodity by market capitalization, has become a significant store of value for institutional treasury companies and Bitcoin mining companies (Miners). Similarly, precious metals such as gold represent trillions in institutional holdings that remain largely underutilized as fixed-income collateral. However, no mechanism has previously existed that:
(a) securitizes Qualifying Assets as the primary collateral pool for a rated, structured fixed-income instrument;
(b) provides investors with a contractual right to participate in Qualifying Asset price appreciation as a component of total return—a “Shared Upside Model”—embedded within a rated asset-backed security;
(c) achieves a formal credit rating from a nationally recognized statistical rating organization (NRSRO) for such an instrument; and
(d) uses a true-sale, bankruptcy-remote multi-entity structure to ring-fence the collateral from the originator's general creditors.

Holders of Bitcoin historically must post 140-160% in collateral and still pay annualized interest rates of 8-10% for terms of one year or less, with limited access to longer-dated financing. There is no existing rated capital markets product through which a Bitcoin-holding entity can obtain multi-year fixed-rate financing at institutional bond rates while simultaneously transferring a portion of the Bitcoin upside appreciation to bondholders as an enhancement to fixed coupon.

Known mechanisms for issuing digital asset-backed securities has involved only informal, bilateral overcollateralized lending arrangements or exchange-traded products (such as spot Bitcoin ETFs) that do not involve the issuance of rated fixed-income notes. No prior structured finance transaction has combined (i) a true-sale securitization framework with Qualifying Asset collateral, (ii) a formal NRSRO credit rating, and (iii) an embedded Qualifying Asset appreciation participation feature in a single integrated instrument. The present invention addresses all of these gaps simultaneously.

### SUMMARY

The present disclosure relates to bonds which are collateralized by a Qualifying Asset, including, without limitation, cryptocurrency and precious metals.

Shared Upside Model/Participation Certificate. The central and most novel feature of the present invention is a contractual mechanism—embedded within the Note indenture—pursuant to which a defined percentage of any appreciation in the price of Qualifying Asset between the closing date and the date of redemption or maturity is allocated to Noteholders and/or a State Conduit Issuer as additional return. This mechanism is referred to herein as the “Shared Upside Model” or “Participation Certificate.” Specifically: (a) a percentage (e.g., fifteen percent (15%)) of the Qualifying Asset appreciation above the initial reference price at issuance is paid to Noteholders as an Appreciation Premium at redemption; and (b) an additional percentage (e.g., twelve and one-half percent (12.5%)) is paid to the State Conduit Issuer as a participation in the Qualifying Asset appreciation. The Shared Upside Model allows the Originator/Sponsor to obtain below-market fixed coupon rates by sharing a contractually specified portion of the potential Qualifying Asset appreciation with investors, creating a novel risk/return profile for rated, institutional fixed-income investors that has no equivalent in any existing listed or OTC market. The Participation Certificate may also be carved out and structured as a standalone, transferable derivative instrument representing a synthetic long-dated call option on the Qualifying Asset—a security type that does not otherwise exist in any listed or OTC market.

True-Sale Bankruptcy-Remote SPV Structure. The invention employs a two-tier, true-sale special purpose vehicle structure: (a) the Originator/Sponsor contributes the Qualifying Asset(s) to a wholly-owned, bankruptcy-remote Depositor (a Delaware limited liability company); (b) the Depositor conveys the Qualifying Asset(s) to a Borrower Trust (a bankruptcy-remote statutory investment trust); and (c) the Borrower Trust pledges the Qualifying Asset(s) to an Indenture Trustee/Collateral Agent as collateral for the Notes. Each conveyance constitutes a “true sale” of the Qualifying Asset(s), removing it from the Originator's balance sheet and insulating it from the Originator's bankruptcy or insolvency.

NRSRO Credit Rating. The invention achieves, for the first time, a formal credit rating from a nationally recognized statistical rating organization for a Qualifying Asset(s)-collateralized asset-backed security, enabling purchase by regulated institutional investors subject to minimum credit rating requirements.

Continuous Automated Collateral Monitoring. The invention incorporates a continuous, automated collateral monitoring regime operating at ten-minute intervals, adapted from margin lending practice and applied for the first time to a rated ABS, with automated LTV trigger mechanics and mandatory liquidation provisions designed for the 24/7 trading characteristics of the Qualifying Asset(s).

The present invention provides a method and system for issuing a Bitcoin-collateralized, rated asset-backed security structured through a bankruptcy-remote special purpose vehicle (SPV) and incorporating a contractual Qualifying Asset price appreciation participation feature (the Participation Certificate or Shared Upside Model). The instrument is structured to comply with established asset-backed securities (“ABS”) legal frameworks, including applicable UCC Articles, and is designed to receive a credit rating from a nationally recognized statistical rating organization.

In one embodiment, the invention comprises: (a) a state conduit issuer that issues revenue bonds or notes on behalf of a Qualifying Asset-holding sponsor; (b) a two-tier, bankruptcy-remote SPV structure consisting of a Depositor entity and a Borrower Trust entity that together hold and isolate the Qualifying Asset collateral through sequential true-sale conveyances; (c) a collateral monitoring and liquidation regime administered by a qualified asset manager; (d) a Shared Upside Model whereby a specified percentage of Qualifying Asset price appreciation accruing over the term of the notes is allocated to investors and the state conduit issuer at maturity or redemption; and (e) an integrated credit rating framework submitted to and evaluated by a major ratings organization.

### BRIEF DESCRIPTION OF THE DRAWINGS

A detailed description of embodiments of the disclosure will be made with reference to the accompanying drawings, wherein like numerals designate corresponding parts in the figures:

FIG. 1 is a transaction structure diagram for a Qualifying Asset-Collateralized Asset-Backed Security.

FIG. 2 is a contract waterfall and agreement flow chart for the transaction structure of FIG. 1.

FIG. 3 is a diagram of an example of a payment waterfall applicable to each payment date and any liquidation event for a structure according to FIG. 1.

### DETAILED DESCRIPTION

The present disclosure relates to systems and methods of issuing bonds which are collateralized by a Qualifying Asset.

For the purposes of this application, the following defined terms have the following meanings:

“Bond” and “note” are used interchangeably herein, meaning debt instruments distributed to Noteholders in exchange for money. “Noteholder”, “bondholder” and “investor” are also used interchangeably herein.

“BTC Premium” or “Appreciation Premium” means a premium payable to Noteholders or Issuer equal to the product of (i) the outstanding principal balance multiplied by (ii) the quotient of the current Bitcoin price divided by the initial Bitcoin reference price, minus one, floored at zero, multiplied by (iii) the participation percentage.

“Participation Certificate” means a contractual obligation to pay the Appreciation Premium incorporated into the Notes, which obligation may be carved out as a standalone transferable instrument.

“Cold Storage” means the practice of keeping private keys offline to protect cryptocurrency assets from online threats, typically using specialized hardware wallets like Ledger, Trezor, or metal backups. It is the most secure method for long-term holding, as it prevents remote hacking, though it offers less convenience than internet-connected “hot” wallets.

“Cryptocurrency” and “crypto” are used interchangeably herein, along with “Bitcoin” and “BTC”. References herein to “cryptocurrency,” “Bitcoin,” “digital commodity,” or “BTC” shall be deemed to include any other Qualifying Asset as an alternative embodiment unless the context expressly indicates otherwise.

“Make-Whole” or “Make-Whole Compensation” means a compensation payment payable to Noteholders upon any optional early redemption of the Notes, in an amount calculated to compensate Noteholders for the loss of future interest payments they would have received had the Notes remained outstanding until maturity, determined in accordance with a formula set forth in the Indenture and, in a preferred embodiment, equal to the excess, if any, of (i) the sum of the present values of the remaining scheduled payments of principal and fixed coupon interest that would otherwise have been payable on the Notes from the redemption date to the stated maturity date, discounted to the redemption date on a semi-annual basis at a rate equal to the yield on a comparable U.S. Treasury security plus a make-whole spread specified in the Indenture, over (ii) the outstanding principal balance of the Notes being redeemed.

“Participation Percentage” means a percentage of the total BTC price appreciation, if any, allocated to Noteholders or Issuer at issuance of the Notes.

“Qualifying Asset” means any tangible or digital asset that: (i) has an observable, liquid market price determinable by reference to a plurality of independent pricing sources or market participants; (ii) is fungible and divisible into standardized units; (iii) is capable of being held by a qualified institutional custodian; and (iv) is capable of being made subject to a first-priority perfected security interest under applicable law. Without limitation, the following constitute Qualifying Assets for purposes of this disclosure: (a) Digital commodities: Bitcoin (BTC) and other digital assets held in qualified institutional cold storage, with pricing determined by a volume-weighted average drawn from a plurality of digital asset exchanges; and (b) Precious metals: gold, silver, platinum, and other precious metals held at recognized institutional bullion vaults subject to third-party account control, with pricing determined by reference to the London Bullion Market Association (LBMA), COMEX, or equivalent recognized commodity pricing benchmarks. The security interest in a Qualifying Asset shall be perfected under UCC Article 9 (for tangible assets) or UCC Articles 8 and 9 (for digital financial assets), as applicable.

“Participation Percentage” means a percentage of the total Qualifying Asset price appreciation, if any, allocated to Noteholders or Issuer at issuance of the Notes.

“Rating Agency” means US rating agencies that are licensed and overseen by the Securities and Exchange Commission (SEC) as Nationally Recognized Statistical Rating Organizations (NRSROs). Established by the Credit Rating Agency Reform Act of 2006, they must register with the SEC, comply with annual reporting, manage conflicts of interest, and be subject to examinations by the SEC Office of Credit Ratings. Examples are Fitch, Standard & Poor's and Moody's. The definition may also apply to similarly-licensed rating agencies in non-U.S. jurisdictions.

“Shared Upside Model” means a collateralized debt obligation wherein a specified percentage of Qualifying Asset or other asset collateral price appreciation while the debt remains outstanding is allocated to investors and/or the State Conduit Issuer, either at maturity or redemption, as embodied by the Participation Certificate.

“Special Purpose Vehicle” or “Special Purpose Entity” (SPV) means a distinct, legally separated entity created by a parent company to isolate financial risk, securitize assets, or perform specific transactions. SPVs allow companies to manage liability, facilitate, and manage complex investments. These entities are often designed to be bankruptcy-remote, protecting the parent firm from liabilities related to the project or assets managed.

“State Conduit Issuer” means governmental or quasi-governmental entities that are legally entitled to issue bonds, including state, city, county, or local governments, as well as their agencies and authorities, to finance public projects such as schools, highways, and hospitals.

In the following description, certain specific details are set forth in order to provide a thorough understanding of disclosed aspects. However, one skilled in the relevant art will recognize that aspects may be practiced without one or more of these specific details or with other methods, components, materials, etc. References herein to United States laws, regulations, rules, governmental or regulatory bodies, market practices, institutional frameworks, or commercial conventions (including without limitation the Uniform Commercial Code, the Securities Act of 1933, Rule 144A, the Securities and Exchange Commission, and nationally recognized statistical rating organizations) shall be deemed to include analogous or similarly-functioning laws, regulations, rules, bodies, practices, frameworks, or conventions of other jurisdictions, to the extent applicable.

Reference throughout this specification to “one aspect” or “one embodiment” means that a particular feature, structure, or characteristic described in connection with the aspect is included in at least one aspect. Thus, the appearances of the phrases “in one aspect” or “in an embodiment” in various places throughout this specification are not necessarily all referring to the same aspect or embodiment. Furthermore, the particular features, structures, or characteristics may be combined in any suitable manner in one or more aspects.

### Parties to the Issuance Transaction

Originator/Sponsor. A Qualifying Asset-holding entity—such as a Bitcoin mining company or institutional Bitcoin holder, a precious metals dealer or commodity fund—that initiates the transaction by contributing Qualifying Asset collateral to the structure. The Originator/Sponsor is the parent and sole member of the Depositor.

State Conduit Issuer. A state-sponsored conduit issuing authority (the Conduit Issuer), such as a state Business Finance Authority, acting under applicable state enabling legislation. The Conduit Issuer issues revenue bonds or notes (the Bonds or Notes) on behalf of the Borrower/SPV and lends the proceeds to the Borrower pursuant to a loan agreement. The Conduit Issuer participates in the Shared Upside Model, receiving a contractual percentage of Bitcoin price appreciation (e.g., 12.5%) realized at maturity or redemption, thereby aligning the state conduit's economic interest with Qualifying Asset appreciation. In other iterations, the Issuer may be a private corporate entity, bank, sovereign entity or wealth fund, or similar entity.

Depositor. A wholly-owned, newly-formed, bankruptcy-remote entity that is a special purpose subsidiary of the Originator. In a preferred embodiment, the Depositor is a Delaware limited liability company or similar entity. The Depositor acquires the Qualifying Asset collateral from the Originator pursuant to the First Cryptocurrency Purchase Agreement (a true-sale conveyance), thereby removing the Qualifying Asset from the Originator's balance sheet and isolating it from the Originator's creditors.

Borrower/SPV (Borrower Trust). A bankruptcy-remote statutory investment trust organized under applicable state law (Borrower Trust). The Borrower Trust holds only the Qualifying Asset collateral; its assets are ring-fenced from the Originator's creditors and from the Depositor's creditors. The Borrower Trust issues the Notes to Noteholders and pledges all of its assets—primarily the Qualifying Asset collateral—to the Collateral Agent for the benefit of Noteholders pursuant to a Collateral Security Agreement. The Borrower Trust constitutes the ABS issuer and is the legal obligor on the Notes.

Noteholders/Investors. Qualified institutional buyers (QIBs) who purchase the Notes pursuant to Rule 144A. Noteholders receive fixed coupon interest, principal at maturity, and a contractual share (e.g., 15%) of any Qualifying Asset appreciation at redemption pursuant to the Shared Upside Model (the “Appreciation Premium”).

Administrator. An institutional digital asset management firm (e.g., a registered investment adviser with substantial experience managing digital assets or commodities as collateral) that is responsible for: (i) monitoring the Collateral Coverage Ratio on a continuous basis; (ii) directing collateral liquidation in connection with scheduled payment dates, optional redemptions, and extraordinary liquidation events; (iii) providing real-time reporting on collateral status; and (iv) exercising discretion to replace the Qualifying Asset Custodian, if warranted.

Back-up Administrator. A Back-up Administrator (an affiliate of the municipal finance partner) is designated to assume the Administrator's duties in the event the primary Administrator is unable to perform. This continuity provision, adapted from traditional ABS servicer backup structures, is specifically tailored for the Qualifying Asset administration context.

Qualifying Asset Custodian. A qualified institutional custodian that holds the Qualifying Asset collateral in segregated custody (cold storage wallets for digital assets; institutional vault storage for precious metals), subject to the exclusive control of the Collateral Agent pursuant to the Custodial and Account Control Agreement. Qualifying Asset pricing data is sourced from an independent digital asset pricing service using a volume-weighted or benchmark methodology drawn from 130+ exchanges or market publications.

Liquidation Agent. A qualified digital asset trading firm that executes market sales of Qualifying Asset collateral upon direction of the Administrator, pursuant to the Liquidation Agreement, in connection with scheduled, optional, or extraordinary (LTV-triggered) liquidation events.

Indenture Trustee/Collateral Agent/Paying Agent. A federally chartered savings bank or trust institution serves simultaneously as Indenture Trustee, Collateral Agent, and Paying Agent. In its capacity as Collateral Agent, this institution holds a perfected first-priority security interest in the Qualifying Asset collateral pursuant to applicable UCC provisions, which is a novel application of those commercial law frameworks to Qualifying Asset as financial collateral.

Rating Agency (NRSRO). The Notes are submitted to a nationally recognized statistical rating organization (NRSRO), specifically a major global credit rating agency, for formal credit rating. This represents the first known submission of a Qualifying Asset-collateralized asset-backed security to a NRSRO for a formal structured finance credit rating.

Sole Placement Agent. The Notes are placed by an institutional broker-dealer as Sole Placement Agent pursuant to Rule 144A under the Securities Act of 1933, restricting initial purchasers to Qualified Institutional Buyers (“QIBs”) with assets under management in excess of $100 million.

### Qualifying Asset Acquisition and True-Sale Conveyance: Sequential Cryptocurrency Purchase Agreements

A novel and critical feature of the present invention is the use of two sequential true-sale conveyances to transfer the Qualifying Asset from the Originator/Sponsor to the Borrower Trust in a manner that achieves bankruptcy-remote isolation, adapted from the mortgage-backed securities “true sale” methodology and applied for the first time to a Qualifying Asset.

First Qualifying Asset Purchase and Contribution Agreement. Pursuant to this agreement, the Originator/Sponsor sells and contributes the Qualifying Asset collateral to the Depositor in exchange for (i) the purchase price (funded by the bond proceeds loaned by the State Conduit Issuer), less transaction costs, and (ii) a residual interest in the transaction. This conveyance constitutes a “true sale” of the Qualifying Asset from the Originator's balance sheet to the Depositor, as evidenced by a true-sale legal opinion delivered at closing. Following this conveyance, the Qualifying Asset is no longer an asset of the Originator/Sponsor and is not available to Originator's creditors in any insolvency proceeding.

Second Qualifying Asset Purchase and Contribution Agreement. Pursuant to This agreement, the Depositor immediately conveys all of its right, title, and interest in the Qualifying Asset collateral to the Borrower Trust in exchange for (i) the purchase price and (ii) a trust certificate representing the residual beneficial interest in the Borrower Trust. This second true-sale conveyance, combined with the first, establishes a complete chain of title from the Originator to the Borrower Trust, insulating the Qualifying Asset from the creditors of both the Originator/Sponsor and the Depositor. A separate true-sale legal opinion is delivered at closing for this agreement.

The two-tier, sequential true-sale structure is novel in the context of Qualifying Asset securitization and is specifically designed to ensure that the Qualifying Asset collateral is treated as an asset of the Borrower Trust (and not of the Originator or Depositor) in any bankruptcy or insolvency proceeding affecting any party.

### Shared Upside Model: BTC Participation Certificate

The Shared Upside Model is the central and most novel feature of the present invention. It is a contractual mechanism—embedded within the Note indenture and Loan Agreement—that allocates a defined percentage of any appreciation in the price of the Qualifying Asset(s) between the closing date of the transaction and the date of Note redemption or maturity to (a) the Noteholders as an “Appreciation Premium” and (b) the State Conduit Issuer as an additional participation payment. This mechanism transforms a conventional over-collateralized Qualifying Asset loan into a structured, rated fixed-income instrument with a built-in Qualifying Asset appreciation feature—effectively embedding a long-dated Qualifying Asset call option within an investment-grade-adjacent rated bond.

In a conventional Qualifying Asset-secured loan, the entirety of any appreciation in Qualifying Asset value accrues to the borrower (i.e., the Originator/Sponsor). The present invention allocates a contractually specified percentage of such appreciation to the Noteholders as an additional return component, in exchange for a below-market fixed coupon rate.

Benefit to Originator/Sponsor: The Originator obtains below-market fixed-rate financing at coupon rates potentially 200-300 basis points below market rates for comparable unrated or high-yield debt, by surrendering a portion (but not all) of the Qualifying Asset commodity upside appreciation.

Benefit to Noteholders: Noteholders receive both a fixed coupon income stream (rated by an NRSRO for creditworthiness) and a contractual right to participate in Bitcoin price appreciation—a novel combination of fixed income and Qualifying Asset commodity upside that has no equivalent in any existing listed or OTC market.

Benefit to State Conduit Issuer: The State Conduit Issuer receives a participation in the Qualifying Asset commodity appreciation in exchange for serving as the conduit issuer of the Notes, providing a mechanism for economic development benefit that is novel in the context of governmental finance.

### Appreciation Premium Formula and Mechanics

The Appreciation Premium payable to Noteholders at redemption or maturity is calculated as follows:

Appreciation Premium=Initial Principal Balance×max (0, (Sale Price of BTC/Initial Reference Price)−1)×Participation Percentage

“Initial Principal Balance” means the outstanding principal balance of the Notes as of the applicable calculation date (i.e., the date on which Qualifying Asset collateral is sold in connection with redemption).

“Sale Price of Qualifying Asset” means the price of the Qualifying Asset(s) (determined using the designated pricing sources) at the time of sale of the Qualifying Asset collateral.

“Initial Reference Price” means the price of the Qualifying Asset(s) as of the closing time on the Closing Date, established using the same pricing sources.

“Participation Percentage” means the contractually specified percentage of Qualifying Asset appreciation allocated to Noteholders (e.g., fifteen percent (15%)).

The Appreciation Premium is floored at $0, meaning that the Appreciation Premium is zero if the Sale Price of the Qualifying Asset is equal to or less than the Initial Reference Price. Noteholders do not bear downside Qualifying Asset price risk beyond the credit protection already embedded in the initial overcollateralization level.

In a preferred embodiment, the Participation Percentage for Noteholders is fifteen percent (15%) and the corresponding participation payment to the State Conduit Issuer is twelve and one-half percent (12.5%), for a combined participation of twenty-seven and one-half percent (27.5%) of any Qualifying Asset appreciation above the Initial Reference Price. The remaining Qualifying Asset appreciation (72.5% of appreciation above the Initial Reference Price) is retained by the Originator/Sponsor as residual upside.

### Participation Certificate as Standalone Derivative Instrument

In addition to being embedded in the Note as the “Appreciation Premium,” the Qualifying Asset appreciation participation right may be “carved out” from the Note structure and issued as a standalone, transferable instrument referred to as a “Participation Certificate” . The Participation Certificate represents a synthetic long-dated call option on the Qualifying Asset—specifically, the right to receive a defined percentage of any appreciation in the price of the Qualifying Asset above the Initial Reference Price over the life of the instrument, paid at exercise or expiry in cash or the Qualifying Asset.

The Participation Certificate, as a standalone instrument, has no equivalent in any existing listed or OTC derivatives market. Listed options on commodities (e.g. Bitcoin or gold) have limited maximum terms on regulated exchanges; over-the-counter options with terms of one year or more are not available in standardized, rated, or institutionally accessible form. The Participation Certificate, by embedding a multi-year Qualifying Asset appreciation participation right within a rated ABS indenture framework, creates a novel and non-obvious derivative instrument that does not otherwise exist.

### Automated Collateral Monitoring, LTV Triggers, and Liquidation Mechanics

Continuous Monitoring Regime. A novel feature of the present invention is the adaptation of continuous automated collateral monitoring—previously used only in bilateral margin lending arrangements—to the context of a rated, publicly placed fixed-income security. The Administrator performs collateral coverage ratio calculations at ten-minute intervals using pricing data sourced from an independent pricing service. For digital asset collateral, pricing data is sourced from a volume-weighted average from more than 130 exchanges. For precious metal collateral, pricing data is sourced from LBMA, COMEX, or equivalent recognized benchmark sources. The Collateral Coverage Ratio is defined as the Current Market Value of Qualifying Asset collateral divided by the sum of outstanding Note principal plus one month's accrued interest and fees.

LTV Trigger and Mandatory Redemption. If the Collateral Coverage Ratio falls to or below the LTV Trigger Threshold (e.g., 140% of outstanding principal plus one month's accrued interest and fees), an LTV Trigger Event is declared, and the Notes are subject to extraordinary mandatory redemption in full. The Liquidation Agent is then directed to execute market sales of Qualifying Asset collateral to fund the Mandatory Redemption Amount.

Payment Waterfall. On each Payment Date and upon any liquidation event, Available Funds are applied in the following priority of payments (the “Payment Waterfall”):

First: Trustee and agent fees; Second: coupon interest payments to Noteholders; Third: principal repayment to Noteholders;
Fourth: make-whole compensation upon optional early redemption;
Fifth: Appreciation Premium (Participation Certificate payout) allocated between Noteholders and the State Conduit Issuer pursuant to the Shared Upside Model; and Sixth: residual amounts to the Borrower Trust or Originator.

### Credit Rating Integration and NRSRO Methodology

Central to the inventive bond issuance system and method described herein is a Participation Note (PN), a novel financial instrument that combines three distinct economic components in a single, rated Asset-Backed Security (ABS) instrument: (a) a conventional fixed-income tranche; (b) structural overcollateralization by Qualifying Asset collateral; and (c) the Participation Certificate representing the Shared Upside Model.

A defining and novel feature of the present invention is the formal submission of the Bitcoin Participation Note to a nationally recognized statistical rating organization (NRSRO) for a formal structured finance credit rating. The preliminary rating assigned (e.g., (P)Ba2 by Moody's Investors Service) reflects the following novel analytical elements that the rating agency must assess for the first time in connection with a Qualifying Asset-collateralized ABS:

(a) assessment of Qualifying Asset price volatility and its impact on the adequacy of initial overcollateralization, using historical price data and stress scenarios calibrated by the NRSRO;
(b) legal analysis of the enforceability of applicable UCC security interests in the Qualifying Asset, including review of true-sale, non-consolidation, and bankruptcy safe harbor opinions; (c) operational risk assessment of the Qualifying Asset Custodian's custody arrangement; (d) assessment of the Administrator's capabilities, including the ten-minute monitoring interval and liquidation execution procedures; and (e) counterparty analysis of all transaction parties.

### Sequencing of the Securitization Process

The issuance of a Participation Note pursuant to the present invention involves a defined sequence of steps. The novel sequencing adapts established ABS closing procedures to the unique requirements of a Qualifying Asset collateral pool and an embedded appreciation participation mechanism. The process proceeds in the following phases:

### Phase A—Pre-Transaction Structuring

The Originator engages the Administrator/Structuring Advisor, Municipal Finance Partner (State Conduit Issuer), Bond Counsel, Placement Agent, and Rating Agency. A Letter of Intent is executed establishing the framework for the transaction. The Administrator, on behalf of the Originator, submits a Bond Financing Application to the State Conduit Issuer. The State Conduit Issuer's governing board adopts a Preliminary Approval Resolution authorizing the proposed bond financing and authorizing the preparation of transaction documents.

### Phase B—SPV Formation and Governance

The Originator forms the Depositor entity (a wholly-owned, bankruptcy-remote Delaware limited liability company) with organizational documents restricting its activities to those necessary for the transaction.

Bond Counsel prepares and files the Certificate of Trust and Short-Form Trust Agreement for the Borrower Trust (a bankruptcy-remote statutory investment trust). The Owner Trustee executes the Short-Form Trust Agreement establishing the Borrower Trust.

### Phase C—Documentation

Bond Counsel prepares the Indenture (governing Note issuance, the Shared Upside Model mechanics, and the Payment Waterfall), the Collateral Security Agreement (governing the pledge of Qualifying Asset collateral to the Collateral Agent), the Loan Agreement (between the State Conduit Issuer and the Borrower Trust), the First and Second Qualifying Asset Purchase Agreements (sequential true-sale conveyances), the Custodial and Account Control Agreement, the Administration Agreement, and the Liquidation Agreement.

### Phase D—Rating Agency Engagement

The Structuring Advisors prepare and submit a comprehensive rating package to the designated NRSRO, including transaction documents, collateral analysis, legal opinions, and operational due diligence materials. A preliminary rating is assigned as a condition precedent to closing.

### Phase E—Collateral Transfer and Closing

The Originator transfers Qualifying Asset collateral (initial Collateral Coverage Ratio of at least 160%) pursuant to the First Qualifying Asset Purchase Agreement. The Depositor conveys the Qualifying Asset to the Borrower Trust pursuant to the Second Qualifying Asset Purchase Agreement. The Borrower Trust pledges the Qualifying Asset to the Collateral Agent pursuant to the Collateral Security Agreement. The Collateral Agent obtains exclusive control of the custodial account, perfecting its first-priority security interest. Qualified legal counsel delivers true-sale, non-consolidation, UCC perfection, bankruptcy safe harbor, tax, and validity opinions. The Indenture Trustee authenticates and delivers the Notes to the Placement Agent for distribution to QIBs pursuant to Rule 144A. The Administrator activates the continuous collateral monitoring regime.

### Detailed Description of the Figures

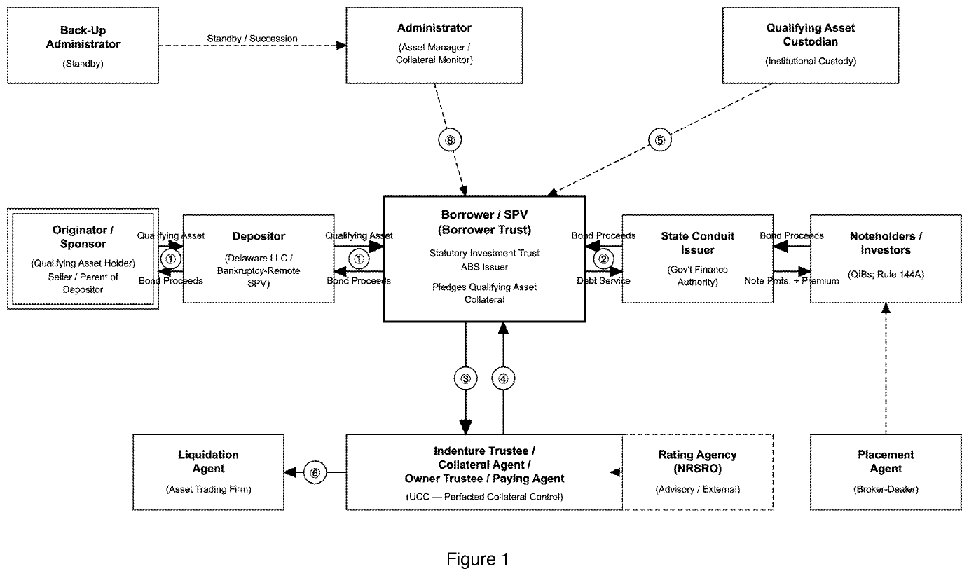

Turning now to the Figures, FIG. 1 is a transaction structure diagram illustrating the party relationships, principal capital flows, and key agreements constituting the Qualifying Asset-Collateralized Asset-Backed Security. In FIG. 1, an Originator/Sponsor contributes

Qualifying Asset collateral to a Depositor in exchange for cash proceeds (Agreement \textcircled{1}: First Qualifying Asset Purchase Agreement), and the Depositor transfers the Qualifying Asset to a Borrower Trust in exchange for a trust certificate and Note proceeds (Agreement \textcircled{1}: Second Qualifying Asset Purchase Agreement). The Borrower Trust, which is a bankruptcy-remote statutory investment trust, then transfers exclusive custodial control of the Qualifying Asset collateral to a Qualifying Asset Custodian pursuant to Agreement \textcircled{5} (Custodial and Account Control Agreement).

The State Conduit Issuer issues Notes to Noteholders in exchange for cash bond proceeds, then lends those proceeds to the Borrower Trust pursuant to Agreement \textcircled{2} (Loan Agreement). The Notes are placed by a Placement Agent pursuant to Rule 144A. The Issuer further enters into an indenture (Agreement \textcircled{3}) with an Indenture Trustee, also acting as Paying Agent, Collateral Agent, and Owner Trustee, wherein the indenture recites the obligations between the Issuer and Noteholders. In the event of a liquidation event, the Indenture Trustee will give notice to the Liquidation Agent (Agreement \textcircled{6}) for liquidation of all or part of the Qualifying Asset collateral to satisfy obligations to the Noteholders.

An Administrator enters into an Administration Agreement (Agreement \textcircled{7}) with the Borrower Trust. The Administrator continuously monitors the collateral coverage ratio and directs collateral liquidation for scheduled payment dates, redemptions, and forced liquidations. A Back-Up Administrator stands ready in standby capacity pursuant to a Back-Up Administration Agreement.

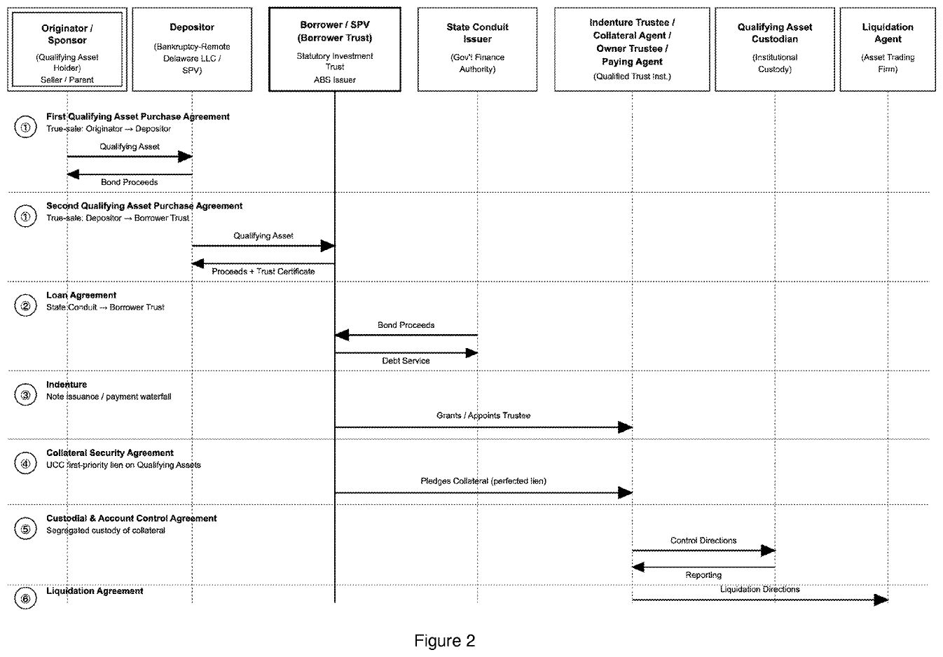

FIG. 2 is a sequence diagram depicting the temporal execution order of six core transaction agreements across the principal parties, comprising: (1) the First Purchase Agreement, effecting the true-sale conveyance of the Qualifying Asset from the Originator/Sponsor to the Depositor; (2) the Second Purchase Agreement, effecting the true-sale conveyance of the Qualifying Asset from the Depositor to the Borrower Trust; (3) the Loan Agreement, pursuant to which the State Conduit Issuer on-lends bond proceeds to the Borrower Trust; (4) the Indenture, executed between the State Conduit Issuer and the Indenture Trustee for the benefit of the Noteholders; (5) the Collateral Security Agreement and related Custodial Agreement, pursuant to which the Qualifying Asset is pledged to the Collateral Agent and held by a qualified custodian subject to account control; and (6) the Liquidation Agreement, pursuant to which a Liquidation Agent stands ready to dispose of the Qualifying Asset collateral in the event of a default or triggering event, wherein directional arrows between swim lanes illustrate the flow of assets, cash, instructions, and obligations between parties, and wherein the vertical axis represents the sequential execution of the agreements from formation through operations.

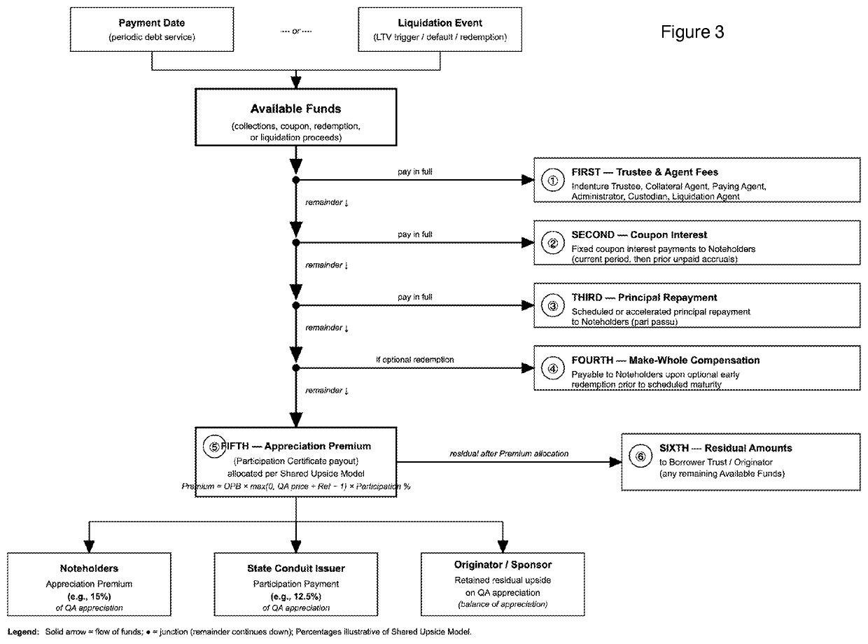

FIG. 3 is a flowchart evidencing the Payment Waterfall for the transaction, where on each Payment Date and upon any liquidation event, available funds are applied in priority: First: trustee and agent fees; Second: coupon interest to Noteholders; Third: principal repayment; Fourth: make-whole upon optional redemption; Fifth: Appreciation Premium (Participation Certificate payout) allocated between Noteholders (e.g., 15%) and the Conduit Issuer (e.g., 12.5

In aspects, application of the present disclosure provides a secure, asset-native way to turn non-fiat assets—including digital commodities and precious metals—into productive institutional capital. It serves public treasury needs, delivers investor-grade risk controls, and integrates with digital asset infrastructure. Applicable sectors include state pension funding, public works, education finance, and strategic reserves. The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed:

1. A commodity-collateralized asset-backed security instrument comprising:
(a) a fixed-income note issued by a conduit issuer, the fixed-income note being secured by a pool of Qualifying Asset collateral held in trust by a bankruptcy-remote special purpose entity;
(b) a contractual mechanism, embedded within an indenture governing the fixed-income note, pursuant to which a defined participation percentage of any appreciation in a market price of the pool of Qualifying Asset collateral above an initial reference price established at issuance is allocated to noteholders as an additional payment at a redemption or maturity, wherein said additional payment is floored at zero such that the noteholders bear no downside exposure to decreases in the price of the Qualifying Asset below the initial reference price; and
(c) a credit rating for the note assigned by a nationally recognized statistical rating organization.

2. The commodity-collateralized asset-backed security instrument according to claim 1, wherein the Qualifying Asset is Bitcoin (BTC), and wherein: (a) the initial reference price is determined via a pricing methodology wherein the market price of Bitcoin as of a closing date of an issuance of the fixed-income note, determined using a volume-weighted average drawn from price data sourced from a plurality of digital asset exchanges; (b) the appreciation in the market price is determined at the time of sale of the Bitcoin in connection with the redemption or maturity, using the same pricing methodology; and (c) the participation percentage allocated to noteholders is between five percent (5%) and thirty percent (30%) of the total price appreciation of Bitcoin above the initial reference price.

3. The commodity-collateralized asset-backed security instrument according to claim 2, wherein:
(a) a portion of the total Bitcoin price appreciation above the initial reference price is allocated to noteholders as the participation percentage; (b) an additional portion of the total Bitcoin price appreciation above the initial reference price is allocated to the State Conduit Issuer; and (c) the remaining Bitcoin price appreciation is retained by the Originator/Sponsor as residual upside.

4. The commodity-collateralized asset-backed security instrument of claim 1, wherein the Qualifying Asset comprises one or more precious metals, including without limitation gold, silver, platinum, palladium, or other precious metals, or securities, certificates, or other instruments representing beneficial interests therein, held in institutional custody at a recognized precious metals vault or qualified custodian maintaining third-party account control, with pricing determined by reference to the London Bullion Market Association (LBMA), COMEX, or other equivalent recognized commodity pricing benchmarks, and wherein the security interest in the Qualifying Asset is perfected pursuant to Article 9 of the Uniform Commercial Code or analogous applicable law.

5. A standalone commodity appreciation participation instrument comprising:
(a) a contractual right, transferable separately from any associated fixed-income note, to receive a payment of a defined percentage of any appreciation in the market price of a Qualifying Asset above an initial reference price established at a time of issuance of the instrument;
(b) said payment right being exercisable at or in connection with a maturity or redemption of an underlying Qualifying Asset-collateralized asset-backed security;
(c) a payment to be made upon exercise of the payment right in cash or in the underlying Qualifying Asset; and
(d) the instrument having a term of greater than one year from its issuance date.

6. A method of structuring a Qualifying Asset-collateralized fixed-income instrument to provide below-market coupon rates to a Qualifying Asset-holding originator and above-market total return potential to fixed-income investors, comprising the steps of:
(a) establishing an initial Qualifying Asset reference price at the closing date of the transaction;
(b) issuing fixed-income notes at a coupon rate that is reduced relative to conventional market rates for comparable instruments, the reduction being economically compensated by a contractual obligation to pay noteholders a defined percentage of any Qualifying Asset price appreciation above the initial reference price at redemption;
(c) continuously monitoring Qualifying Asset collateral value on an intraday basis;
(d) maintaining collateral coverage above a defined minimum threshold; and
(e) upon redemption or maturity, calculating and paying to noteholders the Appreciation Premium equal to the product of
(i) the outstanding principal balance, multiplied by
(ii) the quotient of the current Qualifying Asset price divided by the initial Qualifying Asset reference price, minus one, floored at zero, multiplied by (iii) the participation percentage.

7. A method of securitizing a Qualifying Asset as collateral for the issuance of rated, fixed-income debt securities, comprising the steps of:
(a) transferring the Qualifying Asset from an originator/sponsor to a Depositor embodied as a first bankruptcy-remote special purpose entity pursuant to a first true-sale conveyance agreement;
(b) transferring the Qualifying Asset from the Depositor to a Borrower Trust embodied as a second bankruptcy-remote special purpose entity pursuant to a second true-sale conveyance agreement, thereby establishing a chain of title that removes the Qualifying Asset from the originator/sponsor's balance sheet;
(c) pledging the Qualifying Asset held by the Borrower Trust to a collateral agent pursuant to a collateral security agreement and perfecting a first-priority security interest in the Qualifying Asset under applicable commercial law;
(d) submitting the proposed notes to a nationally recognized statistical rating organization for a formal credit rating; (e) upon receipt of the credit rating, issuing the rated fixed-income notes secured by the pledged Qualifying Asset through the conduit issuer; and (f) continuously monitoring the collateral coverage ratio at intervals of no greater than ten minutes.

8. The method according to claim 7, wherein the Borrower Trust is a statutory investment trust organized under state law, and wherein the collateral agent holds legal title to the Qualifying Asset through an account control agreement with a qualified custodian.

9. The method according to claim 7, further comprising: (a) establishing a loan agreement between a State Conduit Issuer embodied as a state governmental finance authority and the Borrower Trust pursuant to which bond proceeds are on-lent to the Borrower Trust to finance the acquisition of the Qualifying Asset collateral; and (b) granting to the State Conduit Issuer a contractual participation in Qualifying Asset price appreciation pursuant to the Shared Upside Model.

10. A system for continuous automated monitoring of Qualifying Asset collateral securing a rated fixed-income instrument, comprising:
(a) a collateral monitoring agent configured to sample market price data for the Qualifying Asset at intervals of no greater than ten minutes;
(b) the price data being drawn from a volume-weighted average of prices sourced from a plurality of market participants or exchanges;
(c) an automated calculation module configured to compute the collateral coverage ratio as the current market value of the Qualifying Asset collateral divided by the sum of the outstanding note principal, one month of accrued interest, and one month of accrued fees;
(d) an automated notification module configured to issue a mandatory redemption trigger notification to the indenture trustee and liquidation agent if the collateral coverage ratio falls to or below a pre-defined LTV trigger threshold; and
(e) a liquidation agent configured to execute market sales of the Qualifying Asset collateral in an amount sufficient to repay the notes in full upon receipt of a mandatory redemption trigger notification.

11. The system according to claim 10, wherein the Qualifying Asset is Bitcoin, and wherein the LTV trigger threshold is set at approximately 140% of the sum of outstanding principal plus one month of accrued interest and fees, and an initial collateral coverage ratio is not less than 160%.

12. A payment waterfall methodology for a Qualifying Asset-collateralized asset-backed security, comprising the following priority tiers applied to available funds upon any payment date or liquidation event:
(a) First: fees and expenses of transaction service providers;
(b) Second: fixed coupon interest payments to noteholders;
(c) Third: principal repayment to noteholders;
(d) Fourth: make-whole compensation upon optional early redemption;
(e) Fifth: Qualifying Asset appreciation participation payment (Appreciation Premium) allocated between noteholders and any co-issuer pursuant to the Shared Upside Model; and
(f) Sixth: residual amounts to the borrower trust or originator.

13. A method for obtaining a formal credit rating from a nationally recognized statistical rating organization for a Qualifying Asset-collateralized asset-backed security, comprising the steps of:
(a) preparing a rating submission package that addresses Qualifying Asset price volatility under stress scenarios, enforceability of a security interest in the Qualifying Asset held in institutional custody under applicable commercial law, operational risk of a Qualifying Asset custodian's custody arrangement, and counterparty risk of all transaction parties;
(b) providing the nationally recognized statistical rating organization with true-sale, non-consolidation, and bankruptcy safe harbor legal opinions;
(c) demonstrating a continuous automated collateral monitoring regime operating at ten-minute intervals; and
(d) obtaining a preliminary rating as a condition precedent to note issuance.

14. A method for issuing a Qualifying Asset-collateralized asset-backed security incorporating a Shared Upside Model, comprising the steps of:
a) engaging each of a state conduit issuer, structuring advisor, bond counsel, and rating agency and obtaining preliminary approval;
b) forming a bankruptcy-remote depositor embodied as a Delaware LLC and a borrower trust embodied as a state statutory investment trust, each as special purpose entities;
c) preparing and executing each of: sequential Qualifying Asset purchase agreements, an indenture, a collateral security agreement, a loan agreement, a custodial and account control agreement, an administration agreement, and a liquidation agreement;
d) submitting a rating application to the rating agency and obtaining a preliminary credit rating as a condition precedent to a closing; and
e) executing sequential true-sale conveyances of Qualifying Asset collateral, perfecting an applicable UCC security interest under the collateral security agreement, delivering one or more legal opinions from bond counsel, issuing notes to qualified institutional buyers pursuant to Rule 144A, and activating a continuous automated collateral monitoring regime.

15. A method of reducing the fixed coupon rate of a fixed-income instrument by embedding an appreciation participation right, comprising the steps of:
(a) identifying a Qualifying Asset to serve as collateral for the fixed-income instrument;
(b) establishing an initial reference price for the Qualifying Asset as of the closing date of the instrument issuance;
(c) structuring the fixed-income instrument to pay a coupon rate that is below prevailing market rates for comparable instruments, wherein the below-market rate is economically compensated by a contractual obligation to pay instrument holders upon redemption or maturity of the instrument a defined participation percentage of any appreciation in the market price of the Qualifying Asset above the initial reference price;
(d) flooring an appreciation participation right payment at zero, such that instrument holders bear no downside exposure to Qualifying Asset price declines; and
(e) transferring and pledging the Qualifying Asset as collateral to secure repayment of the fixed-income instrument, the Qualifying Asset being held by a bankruptcy-remote entity subject to a first-priority perfected security interest.

16. A structured finance instrument comprising:
(a) a fixed-income note secured by Qualifying Asset collateral held in trust by a bankruptcy-remote special purpose entity;
(b) a contractual participation right, embedded in an indenture or note instrument, entitling a noteholder to receive a defined percentage of any appreciation in the market price of the Qualifying Asset above an initial reference price, payable in cash or in the Qualifying Asset at a maturity or redemption of the fixed-income note;
(c) the contractual participation right being floored at zero;
(d) an automated collateral monitoring regime that monitors the market value of the Qualifying Asset at regular intervals and triggers a mandatory collateral liquidation if a preset collateral coverage ratio falls below a defined threshold; and
(e) a formal credit rating of the structured finance instrument assigned by a nationally recognized statistical rating organization.

17. The structured finance instrument of claim 16, wherein the Qualifying Asset comprises one or more precious metals, including without limitation gold, silver, platinum, palladium, or other precious metals, or securities, certificates, or other instruments representing beneficial interests therein, held in institutional custody at a recognized precious metals vault or qualified custodian, with pricing determined by reference to the London Bullion Market Association (LBMA), COMEX, or other equivalent recognized commodity pricing benchmark, and wherein the security interest in the Qualifying Asset is perfected pursuant to Article 9 of the Uniform Commercial Code or analogous applicable law.

18. The structured finance instrument of claim 16, wherein the Qualifying Asset is a digital commodity, and wherein: (a) the initial reference price is determined using a volume-weighted average of prices sourced from a plurality of digital asset exchanges; (b) the Qualifying Asset is held in institutional cold storage pursuant to a custodial and account control agreement; and (c) the security interest in the Qualifying Asset is perfected pursuant to Articles 8 and 9 of the Uniform Commercial Code.

19. The structured finance instrument of claim 16, wherein the appreciation participation right is divided between two classes of beneficiaries:
(a) a first participation percentage allocated to noteholders as an additional payment at the redemption or maturity; and
(b) a second, separate participation percentage allocated to a conduit issuer or co-issuer that served as the primary obligor on the fixed-income note, each percentage being fixed at issuance and floored at zero.

20. A transferable commodity appreciation participation certificate comprising:
(a) a standalone contractual right to receive a defined participation percentage of any appreciation in the market price of a Qualifying Asset above an initial reference price, the standalone contractual right being separable and transferable independently of any associated fixed-income note;
(b) the standalone contractual right having a defined term of greater than one year;
(c) a payment under the participation certificate being floored at zero such that a certificate holder bears no downside exposure to a Qualifying Asset price decline below the initial reference price; and
(d) the participation percentage and initial reference price being fixed at the time of issuance of the appreciation participation certificate and not subject to adjustment except upon defined extraordinary events.
